(19) United States
(12) Patent Application Publication
(10) Pub. No.: US 2007/0137584 A1
(43) Pub. Date: Jun. 21, 2007

(54) System for monitoring animal feed consumption

(76) Inventor: Bryan R. Travis, Dallas, TX (US)

Correspondence Address: Michael A. O'Neil;Michael A. O'Neil, P.C., Suite 820, 5949 Sherry Lane, Dallas, TX, 75225, US

(21) Appl. No.: 11/378,455

(22) Filed: Mar. 17, 2006

Related U.S. Application Data
(60) Provisional application No. 60/751,143, filed on Dec. 16, 2005.

(51) Int. Cl. A01K 5/02

(52) U.S. Cl. 119/51.02

(57) ABSTRACT

An automated animal feed consumption monitoring system comprises an enclosure having a quantity of feed therein. A sensor detects an animal's entry into a stall adjacent the enclosure and activates the system to record the entry time and entry weight of the feed. An RFID reader, by means of an RFID antenna located along the path of movement of the animal's RFID tag, identifies the specific animal that has entered the stall to feed. When the animal leaves the stall, the exit time and exit weight of the feed are recorded.

### CLAIM OF PRIORITY

Applicant claims priority based on provisional patent application Ser. No. 60/751,143 filed Dec. 16, 2005, the entire content of which is incorporated herein by reference.

### TECHNICAL FIELD

This invention relates generally to animal feed consumption monitoring, and more particularly to a stand alone, autonomous, self-contained feeding station for monitoring animal feed consumption at other outdoor locations such as pastures, feedlots, etc.

### BACKGROUND AND SUMMARY OF THE INVENTION

Investors in cattle destined for feedlots place higher value on animals that are more efficient at converting feed into beef under feedlot conditions. An animal exhibits higher feed conversion efficiency when it consumes less dry feed per unit of weight gained as compared with other animals under the same conditions. Feedlot operators typically bill cattle investors for the feed, medicines, and other services consumed by the investors' cattle during their conditioning for slaughter. Because the cost of feed constitutes the largest part of feedlot costs, the profit or loss realized by investors from feeding animals is directly related to feed conversion efficiency. Investors are therefore motivated to select animals for feeding with preference for those they expect to exhibit better feed conversion efficiency.

Recent scientific research performed at agricultural research facilities has shown that it is possible, through selective breeding, to produce cattle demonstrating higher feed conversion efficiency than is the norm. Progeny of animals determined to have better than normal feed conversion efficiency inherit to a significant degree the feed conversion efficiency of their parents. Thus, the research confirms the possibility of realizing industry wide feed conversion efficiency gains in beef cattle similar to those already achieved in commercial practice through selective breeding within the pig and chicken industries.

Feed conversion efficiency of individual animals within a co-fed group under traditional feedlot conditions is difficult to measure due to the inherent difficulty of determining how much feed each animal has eaten from a communal feed trough. The animal feeding systems described in U.S. Pat. No. 3,465,724, issued to Broadbent on Sep. 9, 1969; U.S. Pat. No. 3,929,277, issued to Byrne, et. al. On Dec. 30, 1975; U.S. Pat. No. 4,049,950, issued to Bryne, et. al. on Sep. 20, 1977; and U.S. Pat. No. 6,868,804, issued to Huisma on Mar. 22, 2005, enable dedicated research facilities to accurately perform research on the feed consumption of individual animals.

The systems described in the above-listed patents are adequate to the needs of scientific research. However, existing systems have not been designed to operate autonomously with high reliability in remote areas, nor have they provided for protection of feed from environmental elements. As a result, cattle breeders seeking to measure and apply feed conversion efficiency as a selection criteria for breeding have heretofore been unable to apply existing systems to feeding environments comprising the harsh conditions experienced at remote outdoor locations such as pastures, feedlots, etc.

The present invention comprises a self-contained system for monitoring animal feed consumption which overcomes the foregoing and other difficulties which have long since characterized the prior art. In accordance with the broader aspects of the invention, a transportable enclosure includes a portal which limits feeding to one animal at any given time. Electronic components located within the enclosure detect and record the arrival time of an animal at the portal, the identity of the arriving animal, the amount of feed consumed by the animal while at the portal, and the departure time of the animal from the portal.

In accordance with more specific aspects of the invention, a solar panel is employed to provide operating power for the electronic components of the system thereby eliminating the need of connecting the system to a power source. The enclosure provides protection for the electronic components from adverse environmental conditions including adverse weather conditions and spurious electrical currents. The identity of each animal entering the portal of the enclosure is determined by reading an RFID tag secured to the animal. The electronic components store data relating to all of the animals monitored by the system for an extended period of time thereby eliminating the necessity of coupling the electronic components to external computing and data storage facilities as is the case with prior art systems.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view illustrating a system for monitoring feed consumption comprising the present invention;

FIG. 2 is a view similar to FIG. 1 further illustrating the system of the present invention;

FIG. 3 is an end view of the system of FIG. 1;

FIG. 4 is a rear perspective view of the system of FIG. 1 showing the access doors of the system in their open configurations;

FIG. 5 is an illustration of the electronic components of the system of FIG. 1;

FIG. 6 is a flow chart depicting the operation of the system of FIG. 1;

FIG. 7 is a top view illustrating two systems of the type shown in FIG. 1 deployed in a single housing; and

FIG. 8 is a top view illustrating four systems of the type shown in FIG. 1 deployed in a single housing.

### DETAILED DESCRIPTION

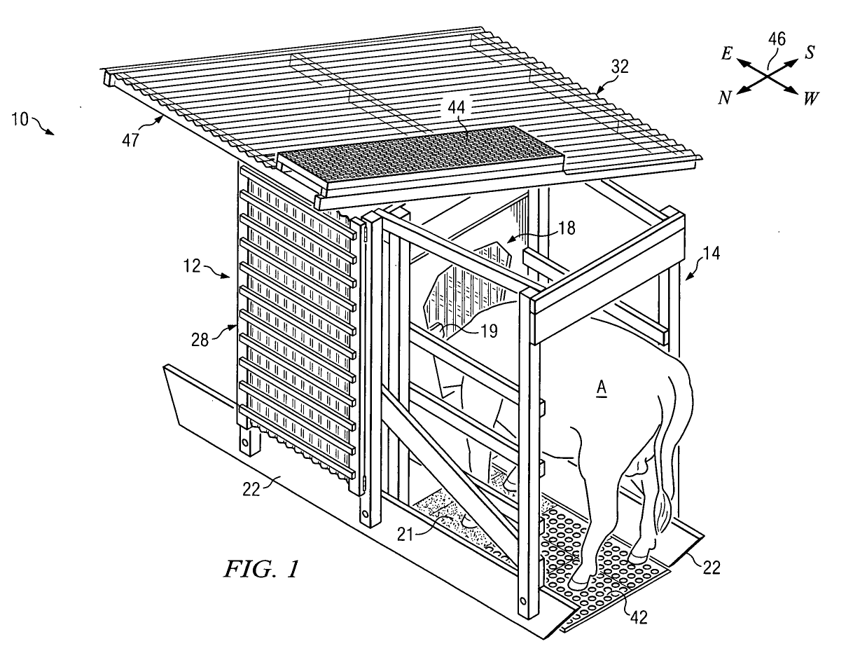

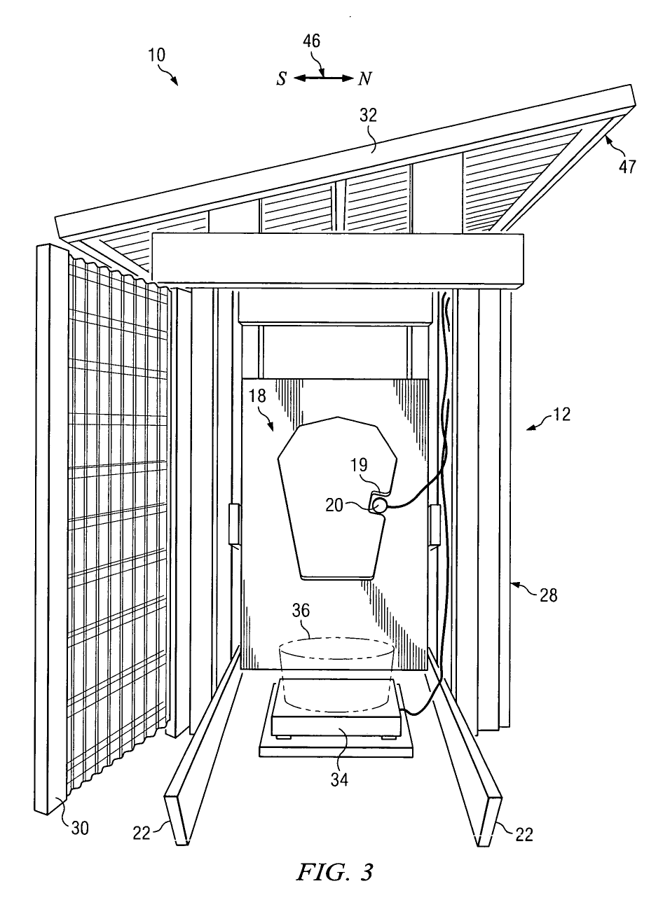

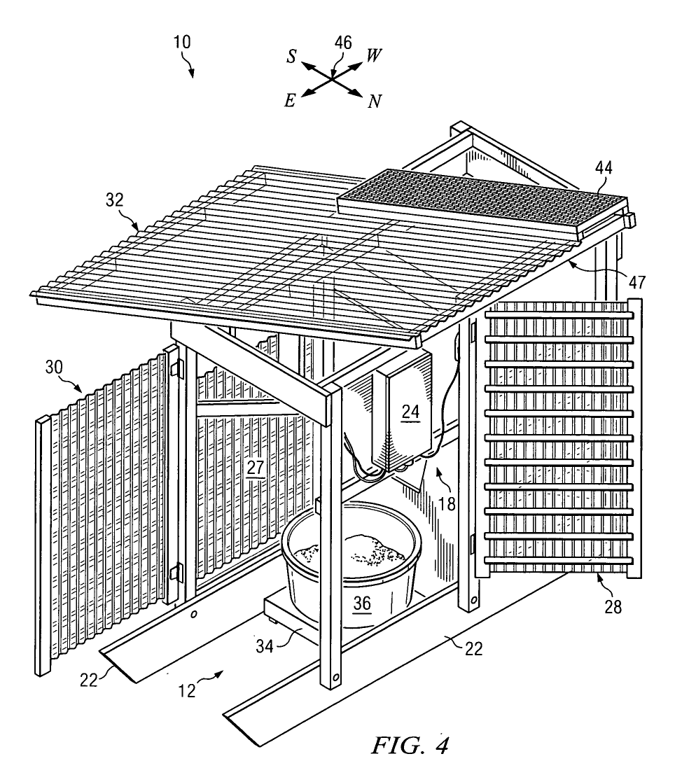

Referring now to the Drawings, and particularly to FIGS. 1, 2, 3, and 4 thereof, there is shown a system for monitoring animal feed consumption 10 comprising a first embodiment of the present invention. The system comprises an enclosure 12, a stall 14, and a portal 18 located between the enclosure 12 and the stall 14. The stall 14 can be a separate structure normally secured to the enclosure 12 and detachable therefrom for transport, etc. The stall 14 and the portal 18 can also be attached to or located inside of a pre-existing outdoor enclosure or barn. Alternatively, the portal 18 can be deployed separately as a stand alone device in appropriate circumstances.

In and of itself the portal 18 comprises an important feature of the invention. The portal 18 includes an intrusion 19 having an RFID antenna 20 secured to the inside surface thereof. The specific shape and placement of the intrusion 19 is such that an RFID tag secured to the ear of an animal utilizing the system 10 passes by the antenna 20 frequently thereby assuring that the tag is (a) seldom missed and (b) read very quickly. Thus, the design of the intrusion 19 permits the use of a less costly RFID antenna 20 having a lower “Q” as compared with typical high gain RFID antennae. The antenna 20 does not require tuning thereby reducing installation difficulties.

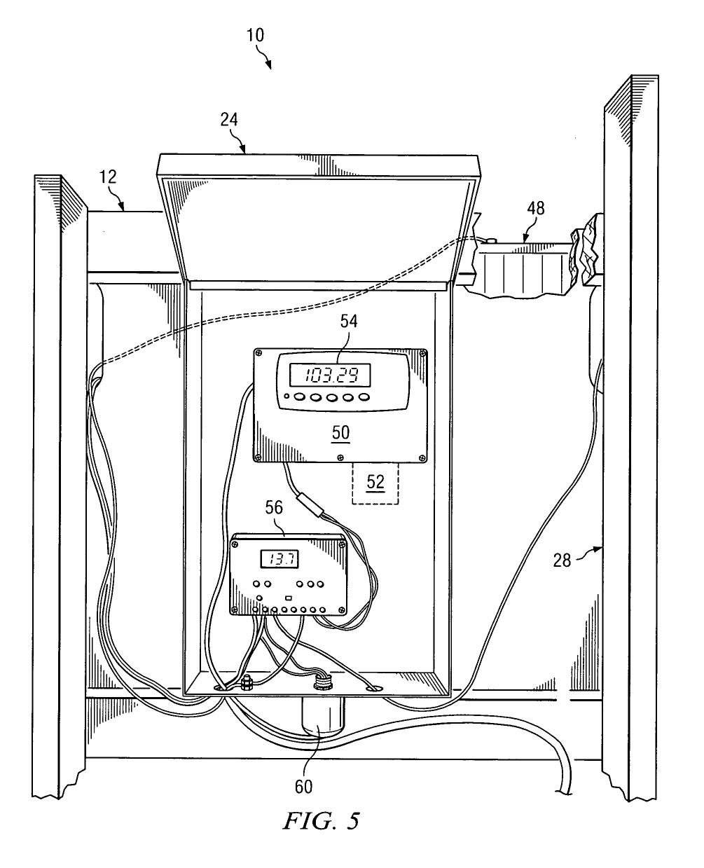

An animal A having an RFID tag secured to its left ear enters the stall 14 and accesses the enclosure 12 through the access portal 18 comprising one wall of the enclosure 12. A sensor 21 within the stall 14 detects the animal's presence and activates a control panel 24 (FIG. 5) having a microcontroller control system therein. The microcontroller control system records the time that the animal A enters the stall (hereinafter the entry time) and the starting weight of the feed (hereinafter the entry weight).

The microcontroller control system continually checks for a valid RFID tag as read by the RFID system comprising the RFID reader and the antenna 20. The animal's identification is thereafter recorded by the microcontroller control system within the control panel 24. Once the RFID tag is read, the control panel 24 remains idle in its low power mode drawing a minimal amount of power while the animal A remains in the stall 14. When the animal A has finished eating and leaves the stall 14 the sensor 21 detects the animal's exit and sends a signal to the control panel 24. Components within the control panel 24 record the exit time and the exit weight of the feed.

The enclosure 12 and the stall 14 are preferably supported on skids 22 which may comprise lengths of 2×10 lumber. The skids 22 facilitate transport of the system 10 between various locations within a pasture, feedlot, or other outdoor location by simply connecting the enclosure 12 and the stall 14 to a pulling device such as a tractor and thereafter dragging the stall 12 and the enclosure 14 from place to place. The skids 22 also facilitate pulling the stall 12 and the enclosure 14 onto a flatbed truck for transportation over longer distances. Those skilled in the art will understand that wheels, rollers, and other devices designed to support the enclosure 12 and the stall 14 for movement over the underlying surface can be used in the practice of the invention in lieu of the skids 22.

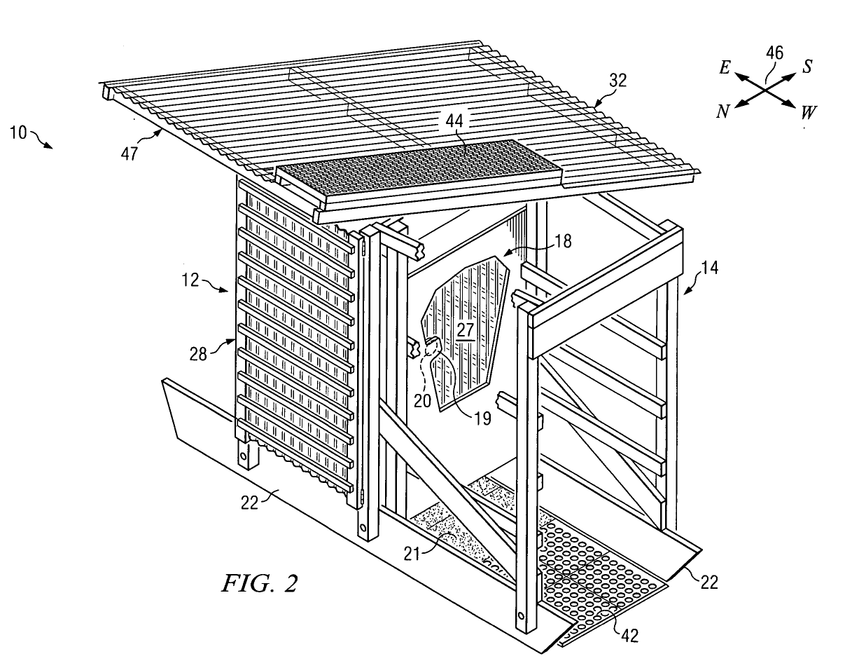

Referring specifically to FIGS. 2, 3, and 4, the enclosure 12 comprises a side wall 27, access doors 28 and 30, a roof 32, and the access portal 18. The enclosure 12 protects the feed therein from contamination by adverse weather conditions such as rain, wind, dust, etc. thereby maintaining the feed in the best possible condition and eliminating the need to replace the feed as it becomes contaminated. The wall 27, the access doors 28 and 30, and the roof 32 comprise substantially transparent panels such as corrugated polymers, PLEXI-GLASS®, or other suitable materials mounted on frames comprising wood, metals, or other suitable materials known to those skilled in the art. The substantially transparent material utilized in the construction of the side 27, the doors 28 and 30, and the roof 32 is important to the construction of the enclosure 12 because the interior of the enclosure 12 must simulate a natural lighting condition similar to that encountered by animals in a pasture thereby assuring that the animal A therein will eat normally. The roof 32 provides substantial coverage of the enclosure 12 and is angled upwardly from the walls 28 thereof thereby protecting the electronic components within the control panel 24 by facilitating natural air flow and enabling heat accumulated within the enclosure 12 to vent. The portal 18 is constructed from a dielectric and non-ferromagnetic material to prevent interference with the electromagnetic field of the RFID antenna 20.

An electronic scale 34 within the enclosure 12 supports a feed bin 36. The scale 34 is connected to the control panel 24 for recording entry and exit weight of the feed within the bin 36. The access door 30 enables access to the system 10 for refilling the feed within the bin 36. As will be understood by those skilled in the art, the functions of the wall 27 and the door 30 may be reversed thereby allowing access to the interior of the enclosure 12 from the side. The portal 18, the wall 27, the normally closed doors 28 and 30, and the roof 32 facilitate accurate weight readings by the scale 34 by eliminating the effects of wind, etc.

A sensor 21 comprising the portion of the floor of the stall 14 adjacent the portal 18 detects both entry of the animal A into and exit of the animal A from the stall 14 and activates the control panel 24 at each occurrence to record either the entry time of the animal and the entry weight of the feed or the exit time of the animal and the exit weight accordingly. The sensor 21 comprises a pressure-sensitive mat for detecting an animal's presence in the stall 14. Other types and kinds of animal sensing devices can also be used in the practice of the invention. A mat 42 comprising the rear portion of the floor of the stall prevents the animal A from digging out the stall area.

A solar panel 44 mounted on the roof 32 provides solar power to all of the components of the monitoring system 10. The enclosure 12 of the system 10 is preferably oriented as indicated at 46 in FIGS. 1, 2, 3, and 4 thereby positioning the solar panel 44 for maximum exposure to the sun. The end 47 of the roof 32 extends substantially beyond the door 28 to provide shade thereby protecting the electronic components of the system 10 from the excessive solar heating thereby maintaining the battery and the electronic components of the system 10 at ambient temperature.

The use of the solar panel 44 to provide operating power for the system 10 comprises an important feature of the invention. The use of solar power in the operation of the system 10 eliminates the need to connect the system to a conventional source of electric power. This in turn facilitates use of the system out of doors in remote locations and also facilitates transport of the system from place to place.

Referring to FIG. 5, a deep cycle lead-acid battery 48 located within the enclosure 12 stores solar power enabling the system 10 to operate in low light conditions such as nighttime and inclement weather. The RFID antenna 20, the components within the control panel 24, and the electronic scale 34 all draw minimal power and operate efficiently on solar power. Because the system 10 can operate independently of external power sources using the solar panel 44 and the battery 48 and does not require constant connection with an external computer, the system 10 is self-sufficient and can be placed in a pasture or other remote area. It will be is understood that the system 10 can also be connected to traditional power sources and re-charged by sources other than solar.

The interior of the control panel 24 is also shown in FIG. 5. The box 50 comprises a microcontroller system circuit board, an RFID reader, and a scale controller. Because of the shape and positioning of the intrusion 19 of the portal 18, the system 10 employs a less costly, lower power consuming RFID reader and antenna system than would otherwise be required. The box 50 may receive removable media cards 52 which are utilized to transfer data from the microcontroller contained within box 50 to remote processing facilities. The box 50 may be provided with a display panel 54 which can be configured to display the weight of the feed contained within the feed bin 36 in pounds, kilograms, or any other measuring unit as may be appropriate to particular applications of the invention.

The control panel 24 further includes a box 56 which contains a solar battery charging and load controller. The box 56 may be provided with a display panel 58 showing the operating status of the components therein in volts, amperes, or watts. Secured to the bottom of the control panel 24 is a lightning suppressor 60 which may comprise a silicon oxide varistor. The function of the lightning and overvoltage suppressor 60 is to prevent spurius electrical currents, whether caused by lightning or otherwise, from interfering with the operation of the components housed within the control panel 24. The lighting supressor may be replaced by or used in combination with numerous other protective components such as ferrites, metal oxide varistors, special diodes, capacitors, chokes and the like.

The control panel 24 comprises a grounded, electrically conductive enclosure which protects the boxes 50 and 56 and the electronic components contained therein from damage from spurious electric currents caused by lightning and otherwise. The boxes 50 and 56 and the components contained therein are electrically isolated from the conductive enclosure except for a single point of common electrical contact with the control panel enclosure 61 which is connected to an earth ground.

The microcontroller control system may be linked to a remote computing system and/or to other feeders via wireless or wired communications methods for purposes of downloading collected data. Data may also be downloaded from the microcontroller control system memory without need of a network or other computing systems by inserting the media card 52 into an interface of the microcontroller control system and initiating built in software functions for downloading data to the media card 52. Over time the data, taken in combination with other data collected about the animal over the same period, such as weight and/or composition of weight gain in terms of fat, muscle, bone, or muscle qualities, will indicate the feed conversion efficiency of the animal A which can thereafter be communicated with other animal performance metrics that are significant in the industry for the estimation of an animal's economic value. Alternative to a media card, the data retrieval media may comprise various memory devices and related communication connectors such as a USB interface, a serial port, an ethernet port, and the like.

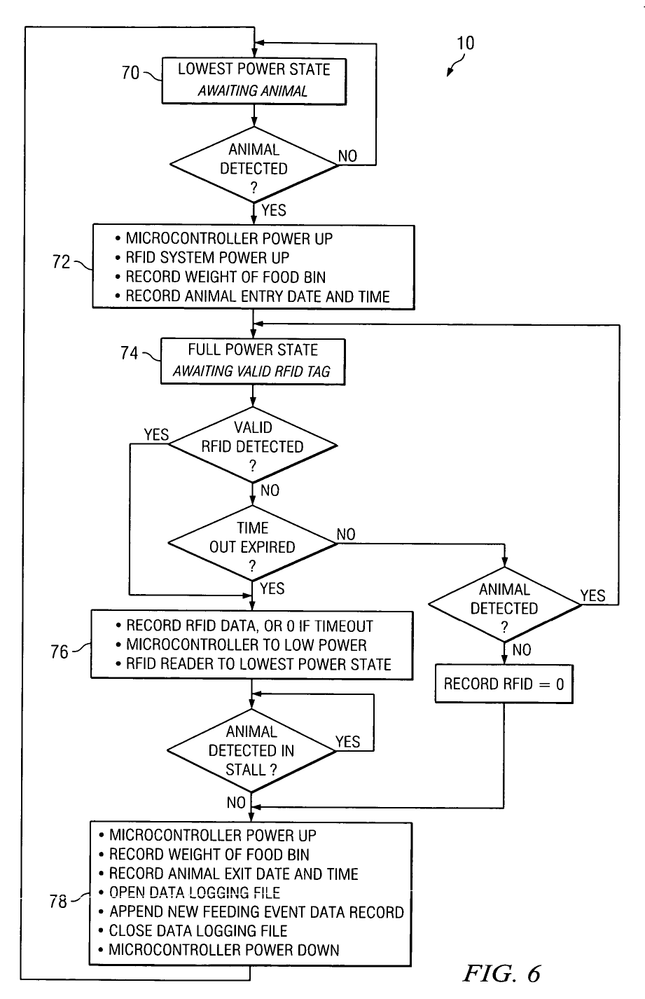

The operation of the system for monitoring animal feed consumption 10 comprising the present invention is illustrated in FIG. 6. Referring to box 70 the system is initially in its lowest power state awaiting the arrival of an animal. As is shown in box 72 when an animal is detected in the stall 14, i.e., when the weight of an animal is detected by the sensing mat 40, the components within the box 50 of FIG. 5 are powered up, the weight of the feed in the feed bin 36 is recorded, and the time and date of the entry of the animal into the stall 14 is recorded. At this point the system is in its full power state as indicated at box 74.

Referring to box 76 if an RFID tag is sensed by the RFID sensor 20 of the portal 18, the RFID data is recorded. Conversely, if an RFID tag is not detected prior to the expiration of an internal time out, the RFID data is recorded as zero. Following the recordal step the microcontroller and the RFID reader are set to their low power states. This conditions continues until the sensing mat 40 no longer detects the presence of an animal in the stall. Referring to box 78 when an animal is no longer detected in the stall, the microcontroller is powered up, the weight of the feed in the feed bin 36 is recorded, the date and time that the animal exited from the stall is recorded, the data logging file is opened to record a new feeding event, the data logging file is closed, and the microcontroller is powered down at which time the circumstance indicated in box 70 is restored. Typically, the full power state is maintained for no more than between about five seconds and about twenty seconds. Most often the full power state is maintained for less than ten seconds as the typical animal behavior and system design facilitates detection of the RFID tag. This permits a very substantial savings of battery and solar power resources.

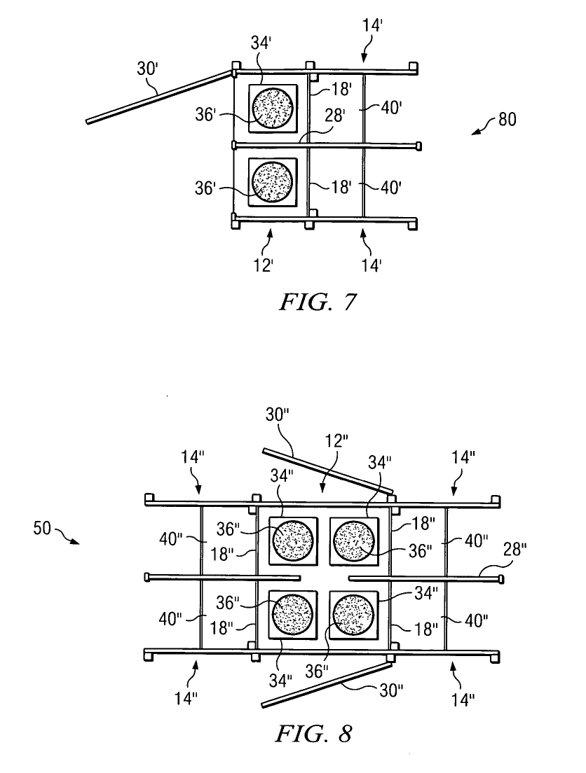

Referring to FIG. 7 there is shown a system for monitoring animal feed consumption 80 comprising a second embodiment of the present invention. Many of the component parts of the feed monitoring system 80 are substantially identical in construction and function to component parts of the feed monitoring system 10 illustrated in FIGS. 1 through 6, inclusive, and described hereinabove in conjunction therewith. Such identical component parts are designated in FIG. 7 with the same reference numerals utilized above in the description of the feed monitoring system 10 but are differentiated therefrom by means of a prime (′) designation.

The feed monitoring system 80 differs from the feed monitoring system 10 in that the feed monitoring system 80 comprises two feed bins 36′ within an enclosure 12′. Accordingly, the enclosure 12′ comprises a second access portal 18′ with its own RFID antenna installed thereon and a second stall 14′ having a second sensor 40′ therein. The enclosure 12′ further comprises an additional wall separating the two feed bins 36′. Each stall 14′ operates independently of the other stall 14′, the only shared components within the system 46 comprising the solar power source, the enclosure 12′, and shared control panel components.

Referring to FIG. 8 there is shown a feed monitoring system 82 comprising a third embodiment of the present invention. Many of the component parts of the feed monitoring system 82 are substantially identical in construction and function to component parts of the feed monitoring system 10 illustrated in FIGS. 1 through 6 and described hereinabove in conjunction therewith. Such identical component parts are designated in FIG. 8 with the same reference numerals utilized above in the description of the feed monitoring system 10 but are differentiated therefrom by means of a double prime (″) designation.

The feed monitoring system 82 differs from the feed monitoring system 10 in that the feed monitoring system 82 comprises four feed bins 36″ within an enclosure 12″. Accordingly, the enclosure 12″ comprises four access portals 18″, each with its own RFID antenna installed thereon. Each access portal 18″ has a stall 14″ adjacent thereto with a sensor 40″ installed in each stall 14″. The enclosure 12″ further comprises an additional wall separating the two pairs of feed bins 36″. Each stall 14″ operates independently of the other stalls 14″, the only shared components within the system 50 comprising the solar power source, the enclosure 12″, and the control panel components.

The multiple feed bin units 80 and 82 illustrated in FIGS. 7 and 8, respectively, are vented as shown in FIGS. 1 through 4, inclusive, with the electronic components thereof located on the north side of the enclosure. In this manner the electronic components are always shaded and thereby protected from damage due to solar heating.

Although the feed consumption monitoring system has been illustrated in conjunction with a bull, the feed consumption monitoring system is equally applicable to pigs, sheep, and various other domestic animals.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A self-contained, transportable system for monitoring the feed consumption of individual animals comprising:
an enclosure;
means supporting the enclosure for movement over the underlying surface;
a container located within the enclosure for receiving a quantity of feed;
means for measuring the weight of the feed in the container;
a stall adjacent the enclosure for receiving an animal therein;
a portal positioned between the enclosure and the stall for receiving the head of an animal located in the stall and thereby permitting the animal to consume feed from the container;
means for detecting the presence of an animal within the stall;
electronic means for recording and storing data;
self-contained means for providing power to the recording and storage means;
a radio frequency identification antenna mounted on the portal and integrated with the recording and storage means; and
a passive radio frequency identification tag secured to the animal.

2. The system according to claim 1 wherein the enclosure is characterized by a roof, an access door, the portal, and a plurality of walls.

3. The system according to claim 2 wherein the roof, access door, and the walls each comprise a substantially transparent material.

4. The system according to claim 1 wherein the electronic storage and recording means housed within a control panel.

5. The system according to claim 1 wherein self-contained means for providing power the electronic recording and storage means comprises a solar power system.

6. The system according to claim 1 wherein in the weight measuring means is an electronic scale.

7. The system according to claim 1 wherein the recording and storage means is a microcontroller system.

8. The system according to claim 7 wherein the microcontroller system is networked or to microcontroller systems of other feeders via wireless communication means.

9. The system according to claim 7 wherein the microcontroller system is networked or to microcontroller systems of other feeders via wired communication means.

10. The system according to claim 1 wherein the recording and storage means is a USB interface.

11. The system according to claim 1 wherein the sensing means comprises a pressure sensitive mat located within the stall.

12. A method for monitoring the feed consumption of individual animals comprising the steps of:
a. providing a transportable structure comprising an enclosure and a stall;
b. providing a portal between the enclosure and the stall;
c. providing a quantity of feed within the enclosure;
d. providing a scale;
e. supporting the quantity of feed on the scale;
f. securing an identification tag to an animal;
g. providing means for detecting an animal's presence within the stall;
h. detecting the entry of an animal into the stall;
i. recording the time and date of entry;
j. simultaneously recording the entry weight of the feed;
k. providing an radio frequency identification antenna;
l. mounting the antenna on the portal;
m. reading a radio frequency identification tag on the animal;
n. recording the animal's identification;
o. detecting the animal's exit from the stall;
p. recording the time of exit and the exit weight of the feed;
q. repeating steps a. through p. over a predetermined period of time;
r. collecting the recorded data and calculating the amount of feed consumed by the animal;
s. providing a self-contained solar powered electrical system for enabling the detecting and recording steps.

13. A method of animal identification comprising the steps of:
a. securing a passive identification tag to an animal;
b. providing an aperture for receiving at least the head of the animal;
c. providing a sensor for reading the passive identification tag on the animal;
d. employing the sensor to read the identification tag when the head of the animal is within the aperture; and
e. recording the identification of the animal as determined in step d.
